(19) United States
(12) Patent Application Publication
(10) Pub. No.: US 2005/0028365 A1
(43) Pub. Date: Feb. 10, 2005

(54) Method for producing a valve seat body of a fuel injection valve

(76) Inventor: Guenter Dantes, Eberdingen (DE)

Correspondence Address: KENYON & KENYON, ONE BROADWAY, NEW YORK, NY, 10004, US

(21) Appl. No.: 10/130,568

(22) PCT Filed: Aug. 25, 2001
(86) PCT No.: PCT/DE01/03265

(30) Foreign Application Priority Data
Sep. 19, 2000 (DE) 100 46 304.5

(51) Int. Cl. B23K 1/20; B23K 17/00

(52) U.S. Cl. 29/890.122; 29/890.12; 29/890.126; 29/890.132

(57) ABSTRACT

A method for manufacturing a valve-seat member of a fuel injector having helical grooves in a recess to generate a swirl, a valve-seat surface of the valve-seat member cooperating with a valve-closure member of fuel injector 1 to form a sealing seat, and the recess being used to guide the valve-closure member. The method includes producing a blank of the valve-seat member, introducing the recess, the valve-seat surface) and at least one spray-discharge orifice into the blank of the valve-seat member and introducing the helical grooves into the recess. The introduction of the helical grooves into the recess is carried out by a non-cutting machining step.

### BACKGROUND INFORMATION

A fuel injector is referred to in German Patent Application No. 42 31 448, in which the fuel injector is provided with helical grooves arranged in a guide bore above the valve-sealing seat to generate a swirl. The helical grooves, which are open toward the valve-closure member, are closed by the valve-closure body guided in the guide bore to form swirl channels. A circumferential groove swirl chamber is arranged downstream from the guide bore, into which the helical grooves discharge with a slight tangential component. Due to the tangential component, the fuel flowing into the swirl chamber obtains a circumferential velocity that fans out a jet of fuel when it exits from the fuel injector, thereby providing an improved atomization.

The helical grooves are introduced into the valve-seat member by machining. Afterwards, burrs produced by the introduction of the helical grooves are removed from the transitions of the helical grooves to the guide bore, and the guide bore and the valve-seat surface are ground. Once the valve-seat member has been cleaned of all work-related residue, such as shavings, coolants and abrasives, the valve-seat member is hardened to ensure a long service life.

It is believed that machining processes are disadvantageous in that they involve additional processing. The burrs, which may be produced by the introduction of the helical grooves, may form in the transition between the helical grooves and the guide bore. These burrs are removed in an additional processing step. Moreover, resulting shavings are removed to prevent early wear of the fuel injector in the guide area and the valve seat.

Furthermore, it is believed to be disadvantageous in that the machining introduces heat into the workpiece, which may be unavoidable, even when coolants are used during the machining. Therefore, a cooling phase may be required prior to checking the valve-seat member for dimensional accuracy.

### SUMMARY

It is believed that an exemplary method according to the present invention has an advantage in that the helical grooves are introduced in a non-cutting manner. In this manner, the formation of burrs may be prevented, and additional work may be reduced during further processing. By omitting one working step, the production costs may be reduced.

The grinding of the guide bore and the valve seat is performed before the helical grooves are introduced into the uninterrupted inner surface of the guide bore of the valve-seat member. The number and geometry of the helical grooves may thus be freely chosen, without having to consider resonant vibrations of the grinding tools, which may occur, such as in the case of grooves already introduced and evenly distributed over the circumference.

Furthermore, it is believed to be advantageous in that the valve seat may be hardened before the helical grooves are introduced. As a result, the circumference of the guide of the valve-closure member may be evenly hardened, since no undesired effects occur, such as those which may occur at the edges of the transition from the helical grooves to the guide bore.

Electro-mechanical metal processing may not cause thermal distortion during the introduction of the grooves. In this manner, the valve-seat member may be checked using a suitable method, such as a template. No cooling of the valve-seat member, which may be warm from the machining, may be required.

### BRIEF DESCRIPTION OF THE DRAWINGS

FIG. 1 is a sectional view through a fuel injector produced using an exemplary method according to the present invention.

FIG. 2 is a detailed sectional view of a portion II of the fuel injector illustrated in FIG. 1.

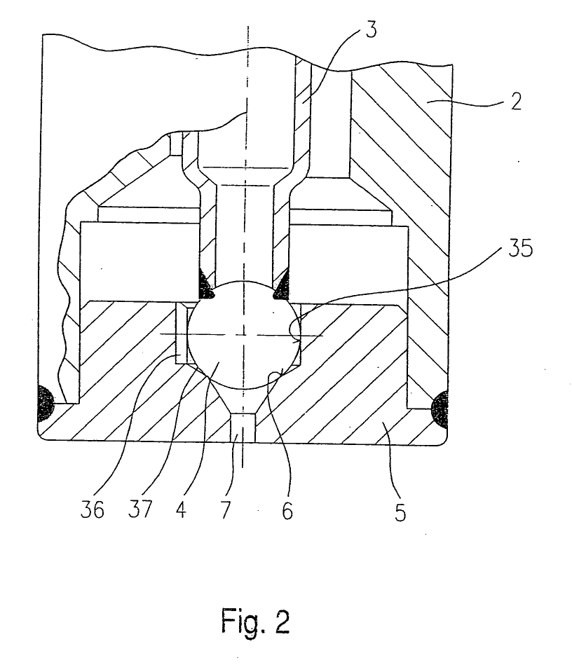

FIGS. 3A-3C are plan views of a valve-seat member showing various geometries of helical grooves.

FIG. 4 is a schematic representation of the metal processing of a valve-seat member.

### DETAILED DESCRIPTION

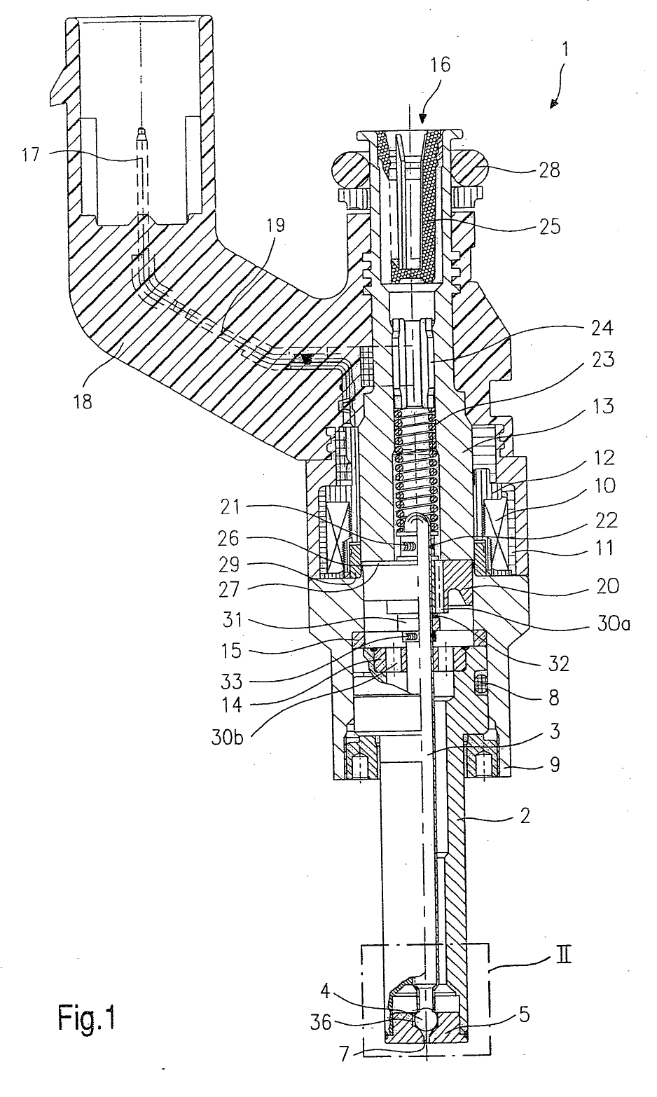

Referring to FIG. 1, fuel injector 1 may be an injector for a fuel-injection system of mixture-compressing internal combustion engines having externally supplied ignition. Fuel injector 1 may be suitable for directly injecting fuel into a combustion chamber (not shown) of an internal combustion engine.

Fuel injector 1 includes a nozzle body 2, in which a valve needle 3 is positioned. Valve needle 3 is connected in operative connection to a valve-closure member 4 that cooperates with a valve-seat surface 6, arranged on a valve-seat member 5, to form a sealing seat. Fuel injector 1, in the exemplary embodiment shown in FIG. 1, is an inwardly opening, electro-magnetically actuatable fuel injector 1 having a spray-discharge orifice 7. Seal 8 seals nozzle body 2 from external pole 9 of a magnetic coil 10. Magnetic coil 10 is encapsulated in a coil housing 11 and wound on a bobbin 12, which lies adjacent to an internal pole 13 of magnetic coil 10. Gap 26 separates internal pole 13 from external pole 9, which are supported on a connecting component 29. Magnetic coil 10 is energized via an electric line 19 by an electric current, which may be supplied via an electrical plug-in contact 17. Plug-in contact 17 is enclosed in a plastic jacket 18, which may be sprayed onto internal pole 13.

Valve needle 3 is guided in a valve needle guide 14, which may be designed, for example, as a disk. A paired adjustment disk 15 adjusts the (valve) lift. An armature 20 is positioned on the other side of adjustment disk 15 and connected by force-locking to valve needle 3 via a first flange 21, and valve needle 3 is connected to first flange 21 by a welded seam 22. Braced against first flange 21 is a return spring 23, which receives an initial stress from a sleeve 24.

A second flange 31, which is connected to valve needle 3 via a welded seam 33, forms a lower armature stop. An elastic intermediate ring 32, which lies upon second flange 31, avoids bounce when fuel injector 1 is closed.

Fuel channels 30a, 30b and grooves 36, respectively, extend through valve needle guide 14, armature 20 and valve seat member 5, which conduct the fuel, supplied via central fuel supply 16 and filtered by a filter element 25, to spray-discharge orifice 7 in valve-seat member 5. Fuel injector 1 is sealed by seal 28 from a distributor line (not shown).

In the neutral position of fuel injector 1, return spring 23, via first flange 21 at valve needle 3, acts upon armature 20 counter to its lift direction, so that valve-closure member 4 is retained in sealing contact against valve-seat surface 6. Upon excitation of magnetic coil 10, the latter generates a magnetic field that moves armature 20 in the lift direction, counter to the spring force of return spring 23, the lift being predefined by a working gap 27 existing in the neutral position between internal pole 13 and armature 20. Armature 20 also carries along, in the lift direction, first flange 21, which is welded to valve needle 3. Valve-closure member 4, being operatively connected to valve needle 3, lifts off from valve seat surface 6, and fuel guided to spray-discharge orifice 7 via fuel channels 30a, 30b and grooves 36, respectively, is sprayed off.

When the coil current is switched off, after sufficient decay of the magnetic field, armature 20 falls away from internal pole 13 due to the pressure of return spring 23 on first flange 21, whereupon valve needle 3 moves in a direction counter to the lift. In this manner, valve-closure member 4 rests on valve-seat surface 6 and fuel injector 1 is closed.

When manufacturing valve-seat member 5 according to the present invention, a blank is first produced, into which a central cut-out 35 for guiding valve-closure member 4, a swirl chamber 37, a valve-seat surface 6 and a spray-discharge orifice 7 are introduced by machining. The shavings produced during processing and any left-over residue from coolants used in machining, are then completely removed.

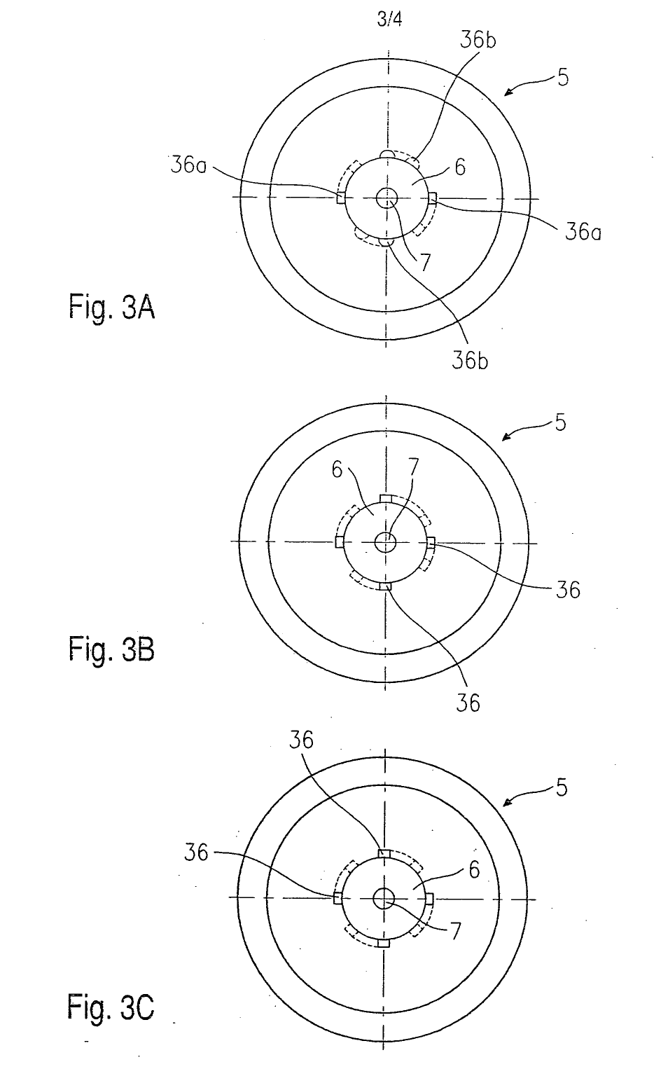

In a subsequent method step, helical grooves 36 are introduced into valve-seat member 5. Helical grooves 36 may differ in their cross-section and extension, as shown in FIGS. 3A through 3C, and may also have a straight shape, with no swirl being generated. Material is removed in a non-cutting manner. Introduced helical grooves 36 are free of burrs and require no further processing steps.

FIG. 3A shows an exemplary embodiment according to the present invention, in which two helical grooves 36a having a rectangular cross section, and two helical grooves 36b having a semi-round cross section are provided.

In the exemplary embodiment according to the present invention shown in FIG. 3B, a plurality of swirl channels 36 having a rectangular cross section and different tangential components are provided. In the exemplary embodiment according to the present invention shown in FIG. 3C, four swirl channels 36 having a rectangular cross section and uniform tangential components are provided.

According to another exemplary embodiment of the present invention, cut-out 35 and valve-seat surface 6 are jointly ground in a manufacturing method according to the present invention, before the helical grooves are introduced. In this manner, valve-seat surface 6 and central cut-out 35 of valve-seat member 5 obtain their final shape and surface properties. Valve-closure member 4 sealingly cooperates with cut-out 35 and valve-seat surface 6. The removed material and the left-over abrasive are removed in one cleaning step. Then, the hardening of valve-seat member 5 occurs. Valve-seat surface 6 and the surface of cut-out 35 for guiding valve-closure member 4 are exposed to strong stresses over the course of their service life. To prevent premature wear of the fuel injector 1, the surfaces are hardened. The rotational symmetry of valve-seat member 5, which as yet does not have any helical grooves 36, facilitates the even grinding and hardening of the surface in cut-out 35.

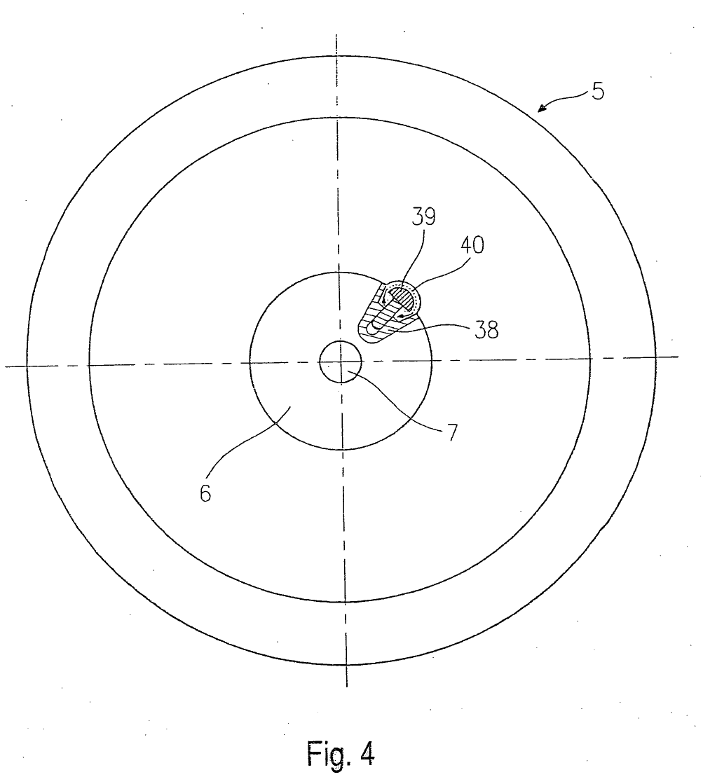

Helical grooves 36 may be introduced into valve-seat member 5 by electro-chemical metal cutting, as illustrated in FIG. 4. In this regard, material is removed by a d.c. current flowing between a tool electrode 39 and a valve-seat member 5. No direct, electrically conducting contact occurs between tool electrode 39 and valve-seat member 5. The current flow occurs via an electrolyte flowing in gap 40. During ablation of valve-seat member 5, tool electrode 39 follows in the radial direction in gap 40, which is enlarged by the ablation procedure, until the desired depth of swirl channel 36 has been reached. By an appropriate design of tool electrode 39, the geometry of the flow-cross section of helical grooves 36 may be determined. Processing in the region of the fully ground valve-seat 5 may be prevented by an appropriate form of tool electrode 39 and a tool holder 38.

Helical grooves 36 may be introduced in valve-seat member 5 by eroding the helical grooves 36.

As a final method step, the introduced helical grooves are checked for form and position. If compliance with the predefined setpoint values is ascertained, by checking with a template, for example, valve-closure member 5 is supplied to the further installation process of fuel injector 1.

1. A method for manufacturing a valve-seat member (5) of a fuel injector (1) having at least one helical groove (36) in a recess (35) to generate a swirl, a valve-seat surface (6) of the valve-seat member (5) cooperating with a valve-closure member (4) of the fuel injector (1) to form a sealing seat, and the recess (35) being used to guide the valve-closure member (4), including the method steps of manufacturing a blank of the valve-seat member (5), introducing the recess (35), the valve-seat surface (6), and at least one spray-discharge orifice (7) into the blank of the valve-seat member (5), and introducing the at least one helical groove (36) into the recess (35), wherein the at least one helical groove (36) is introduced into the recess (35) by a non-cutting machining step.

2. The method for manufacturing a valve-seat member (5) according to claim 1, wherein the at least one helical groove (36) is introduced subsequent to the grinding of the valve-seat surface (6) and of the recess (35).

3. The method for manufacturing a valve-seat member (5) according to claim 1 or 2, wherein the at least one helical groove (36) is introduced after the valve-seat member (5) has hardened.

4. The method for manufacturing a valve-seat member (5) according to one of claims 1 through 3, wherein the at least one helical groove (36) is introduced into the valve-seat member (5) by electrochemical metal processing.

5. The method for manufacturing a valve-seat member (5) according to one of the claims 1 through 3, wherein the at least one helical groove (36) is introduced into the valve-seat member (5) by eroding.

6. The method for manufacturing a valve-seat member (5) according to one of the claims 1 through 5, wherein the position of the helical groove (36) relative to the spray-discharge orifice (7) is checked after the helical groove (36) has been introduced.
